(19) United States
(12) Patent Application Publication
(10) Pub. No.: US 2026/0304120 A1
(43) Pub. Date: Oct. 1, 2026

(54) METHODS, APPARATUSES AND SYSTEMS FOR USER EQUIPMENT-NETWORK FUNCTION END-TO-END SECURE COMMUNICATIONS

(71) Applicant: InterDigital Patent Holdings, Inc., Wilmington, DE (US)

(72) Inventors: Samir Ferdi, Kirkland (CA); Alec Brusilovsky, Downingtown, PA (US); Zhibi Wang, Woodridge, IL (US); Chonggang Wang, Princeton, NJ (US); Ulises Olvera-Hernandez, Saint-Lazare (CA); Yi Zhang, San Jose, CA (US)

(21) Appl. No.: 19/092,361

(22) Filed: Mar. 27, 2025

(51) Int. Cl. H04W 12/069; H04W 12/041

(52) U.S. Cl. CPC H04W 12/069; H04W 12/041

(57) ABSTRACT

In an embodiment, a method, implemented in a wireless transmit/receive unit, WTRU, comprises receiving a first message comprising first information indicating connection information with network functions of a network; generating a first communication key for communication security establishment with the network functions of the network and an identifier of the first communication key based on an authentication with the network; generating a second communication key of a first network function of the network based on the first communication key and based on the connection information; transmitting a request message to the first network function comprising second information indicating the identifier of the first communication key; performing a mutual authentication with the first network function based on the generated second communication key of the first network function; and performing one or more communications with the first network function based on the generated second communication key of the first network function.

### FIELD OF THE INVENTION

The present disclosure is generally directed to methods, architecture apparatuses and systems for user equipment-network function end-to-end communications. More particularly, the present disclosure relates to methods for a user equipment to establish a secure connection over a control plane or a user plane with a network function using a shared key derived from a network communication root key.

### BACKGROUND

Current 5G system may present a tight coupling and aggregation of multiple functionalities at access and mobility management function (AMF) (e.g., security, mobility management (MM), Non-Access Stratum (NAS) transport for all network services). As a result, functionalities inter-dependencies and overlap (e.g., MM, Session Management (SM)) may hinder the system scalability and ease of new features implementation and deployment. Furthermore, the system may lack support for proper security isolation (e.g., AMF common to multiple network slices) or security differentiation (i.e., “one size fits all” as in NAS level security serving/applicable to all NFs/services).

The control plane (CP)-based user equipment-network function (UE-NF) communication may be not adapted for the high amount of data transfer foreseen for emerging new use cases such as artificial intelligence/machine learning (AI/ML) or sensing. At the same time, the current mechanism defined for user plane (UP) communications between user equipment (UE) and location management function (LMF) for location services (LCS) may present the following drawbacks and limitations. The LCS procedures defined may be specific to LCS services, may be tightly coupled with AMF and NAS MM transport for UP connection management, and may not support mutual authentication. In other words, the LMF may not authenticate the UE, and only server-side (LMF) authentication may be supported using transport layer security (TLS) protocol. Instead, the procedures may use an intricate protocol for “binding” the TLS connection to the UE via the NAS connection and AMF assistance using a “binding ID” allocated by the LMF.

Based on the above, it is therefore desirable for new wireless system (e.g., 6G System) to support a more modular approach for UE-NF secure communications while supporting both CP and UP-based communications.

Hence the following issue need to be addressed: How to enable secure direct communications between UE and an NF, independently from other NFs security context (e.g., AMF) while supporting both, CP and UP-based approaches?

### SUMMARY

In an embodiment, a method, implemented in a wireless transmit/receive unit (WTRU), may comprise a step of receiving a first message comprising first information indicating connection information with network functions of a network. The first message may be received during a non-access stratum procedure. The method may further comprise a step of generating a first communication key for communication security establishment with the network functions of the network and an identifier of the first communication key based on a first authentication with the network. The method may further comprise a step of generating a second communication key of a first network function of the network based on the first communication key and based on the connection information. The method may further comprise a step of transmitting a first request message to the first network function comprising second information indicating the identifier of the first communication key. The method may further comprise a step of performing a mutual authentication with the first network function based on the second communication key of the first network function; and a step of performing one or more communications with the first network function based on the second communication key of the first network function. Performing the one or more communications with the first network function may be under a security protocol.

The first communication key may be a root key determined based on the first authentication with the network, wherein the first authentication with the network may be a primary authentication. The second communication key may be a unique shared key for secure communication with the first network function.

The method may further comprise a step of generating the first communication key based on a third communication key of the network established during a second authentication with the network. The third communication key may be an anchor key or an intermediate key determined based on the second authentication with the network. The first information may further indicate a lifetime for the second communication key of the first network function. Performing the one or more communications with the first network function may be on condition that the lifetime for the second communication key is valid.

The mutual authentication may be performed using an authentication protocol. The connection information with the network functions may indicate any of the authentication protocol, an identifier of the first network function, and a freshness parameter.

The method may further comprise a step of transmitting the first request message to the first network function over a user plane of the network, or a control plane of the network. The first request message may be a connection request message.

The first message may be a registration accept message, such that the method may comprise a step of, prior to receive the first message, transmitting, to the network, a registration request message comprising WTRU to network function communication security capabilities information indicating the security protocol. The method may further comprise a step of establishing a PDU session, wherein the establishment of the PDU session is to enable communication with the first network function.

In an embodiment, a wireless transmit/receive unit (WTRU) comprising a processor, a transmitter, a receiver, and a memory, may be configured to receive a first message comprising first information indicating connection information with network functions of a network. The WTRU may be further configured to generate a first communication key for communication security establishment with the network functions of the network and an identifier of the first communication key based on a first authentication with the network. The WTRU may be further configured to generate a second communication key of a first network function of the network based on the first communication key and based on the connection information. The WTRU may be further configured to transmit a first request message to the first network function comprising second information indicating the identifier of the first communication key. The WTRU may be further configured to perform a mutual authentication with the first network function based on the second communication key of the first network function; and configured to perform one or more communications with the first network function based on the second communication key of the first network function.

In an embodiment, a method, implemented in a network node of a network, may comprise a step of receiving a first request message comprising first information indicating a first identifier of a wireless transmit/receive unit (WTRU), a first communication key for communication security establishment with network functions of the network, and a second identifier of the first communication key. The method may further comprise a step of determining one or more communication information based on the first information, wherein the one or more communication information may be respectively associated with one or more network functions for communication establishment with the WTRU. The method may further comprise a step of transmitting a first response message comprising second information indicating the one or more communication information. The method may further comprise a step of receiving a second request message comprising third information indicating the second identifier of the first communication key and a first communication information of the second information, wherein the first communication information may be associated with a first network function of the one or more network functions. The method may further comprise a step of generating a second communication key of the first network function based on the first communication key and the third information; and a step of transmitting a second response message comprising fourth information indicating the first identifier of the WTRU, and the second communication key.

The method may further comprise a step of determining one or more network functions authorized for end-to-end communication with the WTRU based on the first information, wherein the one or more communication information is (are) associated with the authorized one or more network functions, e.g., respectively. The one or more communication information may indicate any of one or more identifiers of respectively the one or more network functions, an authentication protocol and a security protocol.

The method may further comprise a step of determining the one or more communication information further based on any of subscription data of the WTRU from a unified data management function, policy information, and capabilities of the WTRU.

The fourth information may further indicate a key lifetime associated with the second communication key. The one or more communication information may indicate one or more communication key lifetime associated with respectively one or more communications between the WTRU and the one or more network functions.

The method may further comprise a step of storing, in a WTRU key management context the indication of the first information and/or the indication of the fourth information.

The network node may comprise a key management function for a network key management service for any of the network functions and the WTRU. The first communication key may be a root key determined based on a primary authentication between the network and the WTRU. The second communication key may be a unique shared key for secure communication between the first network function and the WTRU.

### BRIEF DESCRIPTION OF THE DRAWINGS

A more detailed understanding may be from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is an example of a block diagram illustrating an example of a non-roaming 5G system architecture according to an embodiment;

FIG. 3 is an example of a block diagram illustrating an example of a security key hierarchy in 5G system according to an embodiment;

FIG. 4 is an example of a signaling diagram illustrating an example of a procedure wherein a WTRU initiates a user plane connection establishment according to an embodiment;

FIG. 5 is an example of a block diagram illustrating an example of an hybrid system architecture for WTRU-Network function (NF) communication according to an embodiment;

FIG. 6 is an example of a block diagram illustrating an example of an evolved system architecture for WTRU-Network function (NF) communication according to an embodiment;

FIG. 7 is an example of a block diagram illustrating an example of a key hierarchy for end-to-end communication between a WTRU and a NF in home public land mobile network (HPLMN), according to an embodiment;

FIG. 8 is an example of a block diagram illustrating an example of a key hierarchy for end-to-end communication between a WTRU and a NF in visited public land mobile network (VPLMN), according to an embodiment;

FIG. 9 is an example of a signaling diagram illustrating an example of a procedure for a WTRU end-to-end secure connection establishment with a NF over a user plane, according to an embodiment;

FIG. 10 is an example of a signaling diagram illustrating an example of a procedure for a WTRU end-to-end secure connection establishment with a NF over a control plane, according to an embodiment;

FIG. 11 is an example of a signaling diagram illustrating an example of a procedure for a WTRU end-to-end secure connection establishment with a NF in a HPLMN, according to an embodiment;

FIG. 12 is an example of a signaling diagram illustrating an example of a WTRU-NF communication using key distributed to a WTRU over a user plane, according to an embodiment;

FIG. 13 is an example of a signaling diagram illustrating an example of a procedure to establish a secure end-to-end connection between a WTRU and a NF over a user plane initiated by the network and based on network access security, according to an embodiment;

FIG. 14 is an example of a signaling diagram illustrating an example of a procedure to establish a secure end-to-end connection between a WTRU and an NF over a user plane initiated by the network and based on network access security, according to another embodiment;

FIG. 15 is an example of a flow chart diagram illustrating an example of method, implemented in a WTRU, for a WTRU end-to-end secure connection establishment with a NF, according to an embodiment; and FIG. 16 is an example of a flow chart diagram illustrating an example of a method, implemented in a network node, for a WTRU end-to-end secure connection establishment with a NF, according to an embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

Hereinafter, “a” and “an” and similar phrases are to be interpreted as “one or more” and “at least one”. Similarly, any term which ends with the suffix “(s)” is to be interpreted as “one or more” and “at least one”. The term “may” is to be interpreted as “may, for example”.

A sign, symbol, or mark of forward slash “/” is to be interpreted as “and/or” unless particularly mentioned otherwise, where for example, “A/B” may imply “A and/or B”.

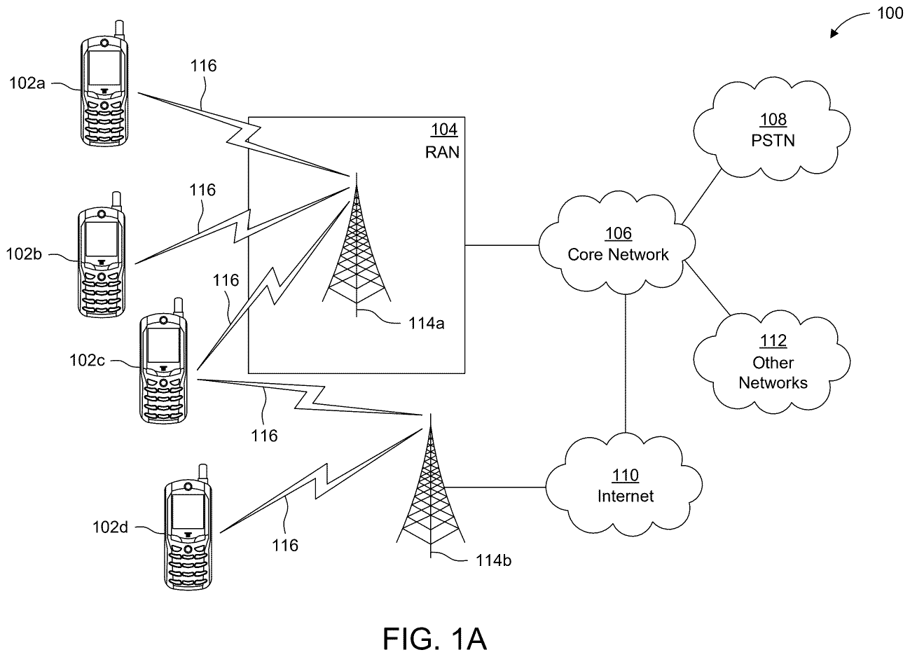

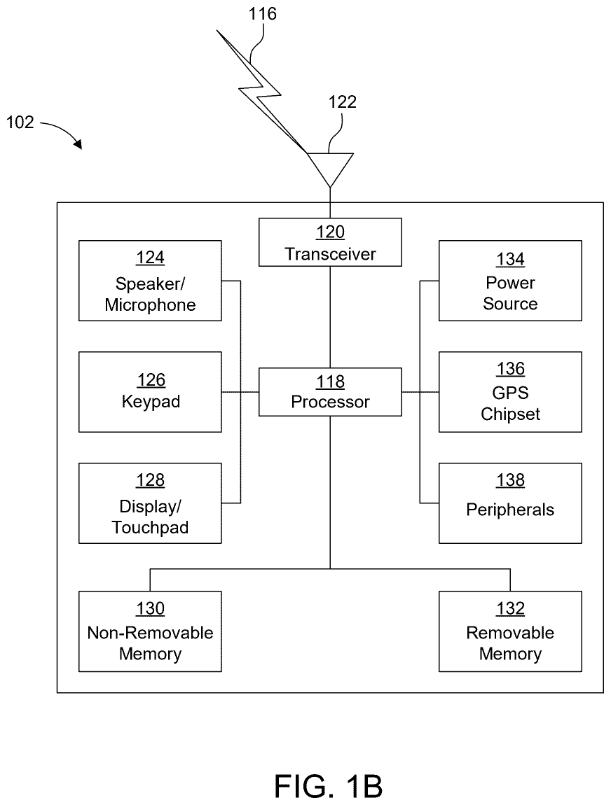

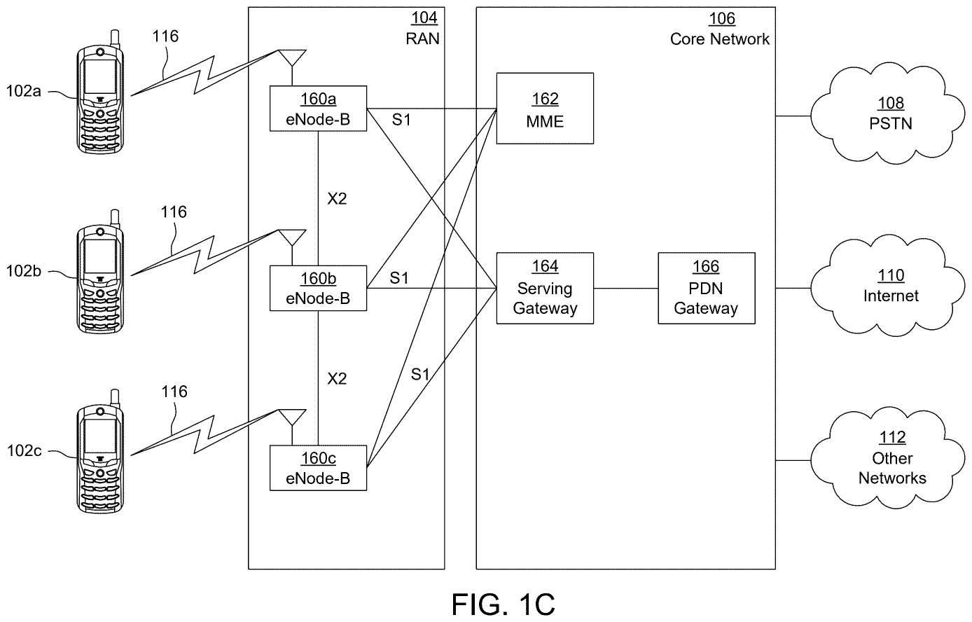

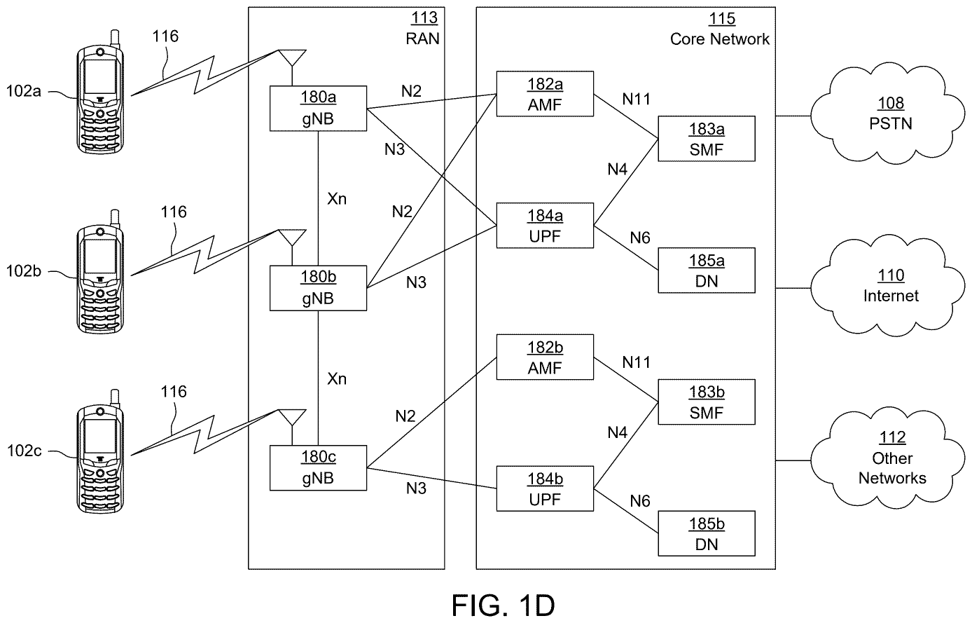

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHZ, 4 MHz, 8 MHz, and 16 MHz bandwidths using non-TVWS spectrum. According to a representative embodiment, 802.11ah may support meter type control/machine-type communications, such as machine-type communications devices in a macro coverage area. Machine-type communications devices may have certain capabilities, for example, limited capabilities including support for (e.g., only support for) certain and/or limited bandwidths. The machine-type communications devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHZ, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in an uplink (UL) and/or downlink (DL), support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one access and mobility management function (AMF) 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of Non-Access Stratum (NAS) signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device (e.g., a network node) may be directly coupled to another device for purposes of testing and/or may performing testing using over-the-air wireless communications.

The one or more emulation devices may perform the one or more, including all, functions while not being implemented/deployed as part of a network node (e.g., wired and/or wireless communication network). For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

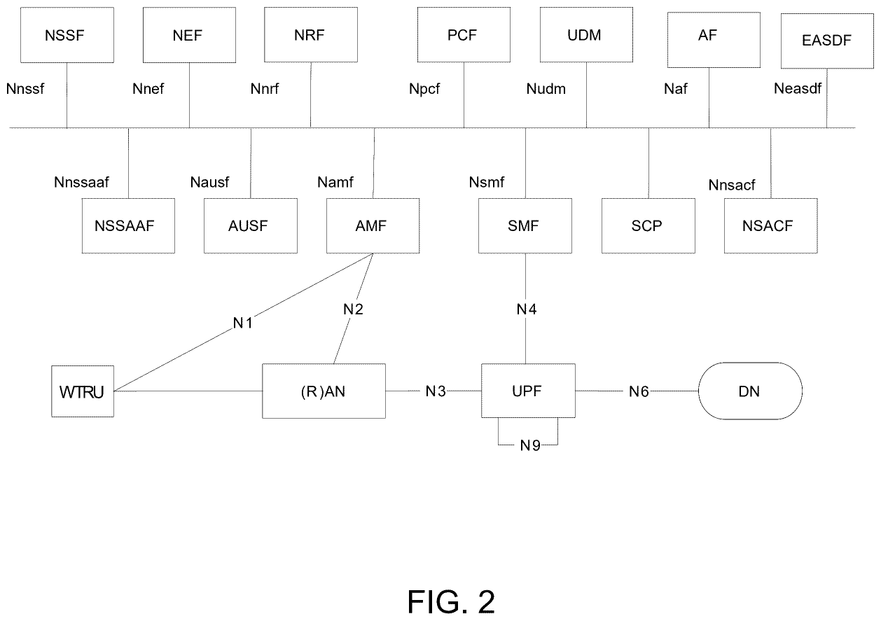

Referring to FIG. 2, in current wireless system (5G system), all NAS signaling between a WTRU and a 5G core network (5GC) may terminate at the AMF (shown as the N1 interface in FIG. 2). A WTRU may communicate with other 5GC NFs (e.g., SMF) using NAS transport via AMF by means of dedicated (e.g., SM) transparent containers, which AMF forwards using a service-based interface (SBI) (e.g., invoking Nsmf service). A NAS connection between a WTRU and an AMF may be secured using NAS keys (K_{NASint}, K_{NASenc}) derived from a K_{AMF} established during a WTRU primary authentication.

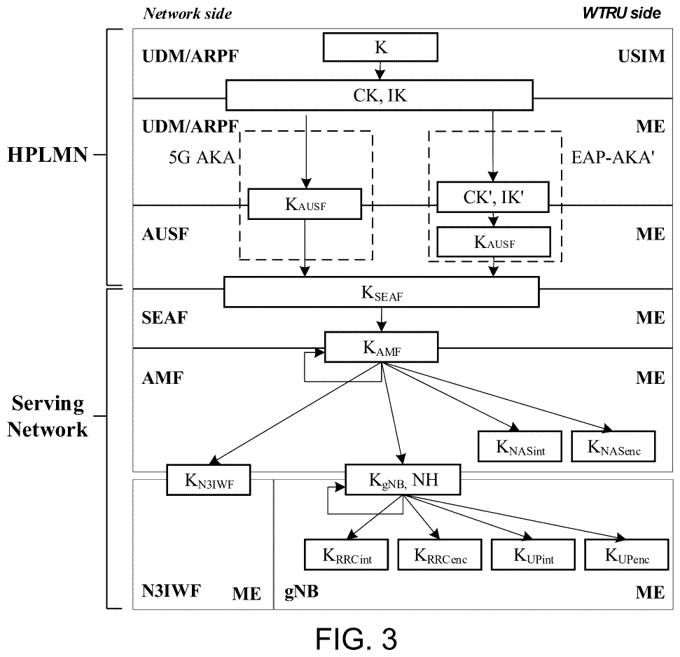

Referring to FIG. 3, an example of a block diagram illustrating a security key hierarchy is shown.

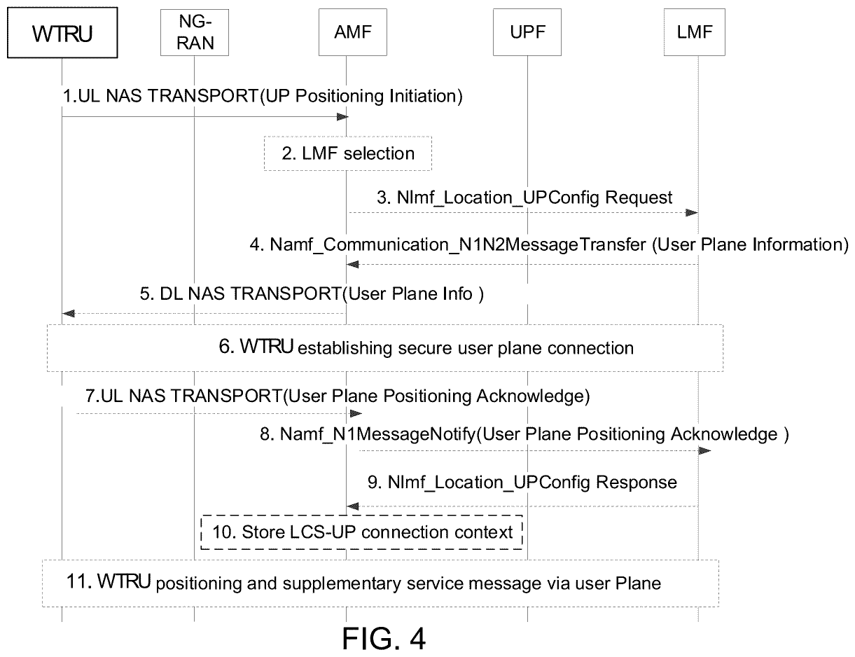

3GPP has defined mechanisms for communications over a UP between a WTRU and a termination point in a 5GC (LMF) for a location services (LCS) feature. Referring to FIG. 4, a procedure where a WTRU may initiate a UP connection establishment with LMF using (CP) NAS message exchange with the AMF is shown.

3GPP is studying how to support standardized means of data transfer over UP between a WTRU and a 5GC for WTRU data collection. The purpose of the data collection may be for WTRU-side model training, needed for AI/ML for air interface operations. The transfer/delivery of the trained model to the WTRU may also be part of the data transfer over UP.

In the various embodiments below, mechanisms may be described where a wireless system (e.g., 6GS) may enable secure end-to-end communication between a WTRU and a NF in the core network (e.g., 6GC). The WTRU may establish a secure connection over CP or UP with the NF that may use a shared key (e.g., K_{NF}). The K_{NF} may be derived from an NF communication root key (e.g., K_{KMF}). The K_{KMF} may be derived by the WTRU and the network (e.g., security anchor function (SEAF) or authentication server function (AUSF)) using a network anchor key (e.g., K_{SEAF}, K_{AMF}) or a network intermediate key (e.g., K_{AUSF}) during a NAS procedure (e.g., registration, primary authentication). The K_{NF} may be derived by the WTRU. The K_{NF} may be derived by the network, for example, by a key management function (KMF) during a NAS procedure (e.g., registration, protocol data unit (PDU), session establishment) or connection establishment between WTRU and the network (e.g., NF). The secure connection between the WTRU and the NF may be established in a secure key agreement/transport protocol (e.g., TLS, IKEv2) which may use K_{NF} as a pre-shared key (PSK). The NF may retrieve K_{NF} from KMF using a key identifier K_{KMF} ID. The K_{KMF} ID may be received from the WTRU during the procedure.

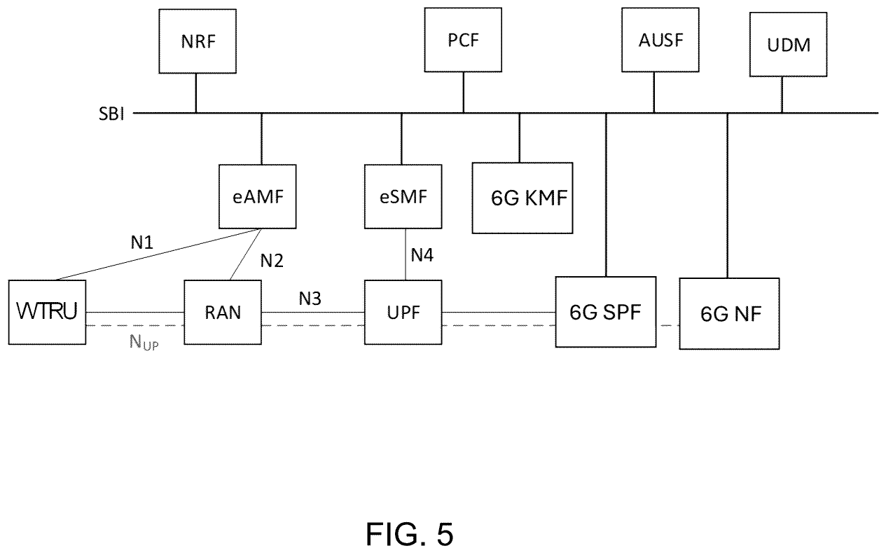

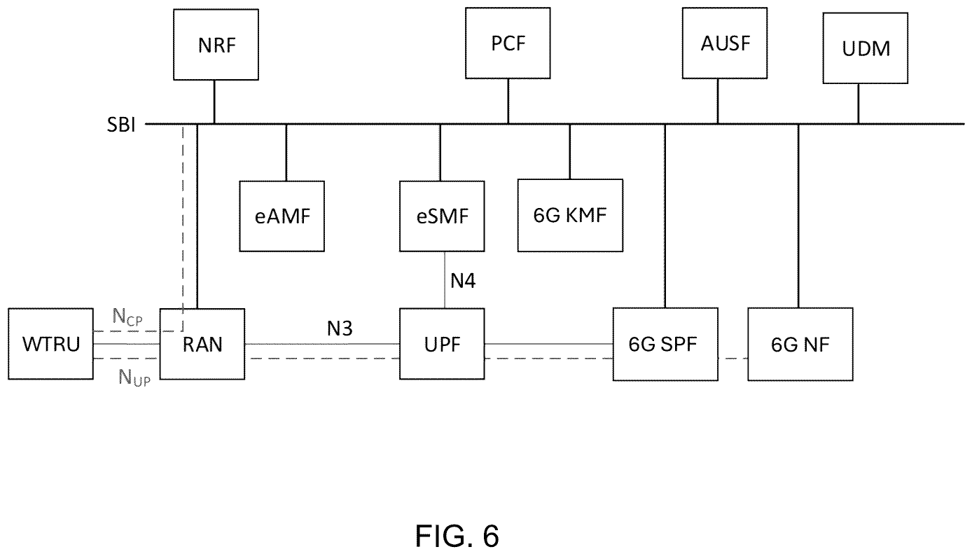

FIG. 5 and FIG. 6 illustrate examples of architecture of a system to support secure end-to-end WTRU-NF communications. Referring to FIG. 5, an example of a “hybrid” system architecture for WTRU-NF communication is shown. The WTRU may use a conventional N1 interface for CP-terminated communication with legacy/evolved 5G system (5GS) functions (e.g., MM, SM, PCF). The WTRU may communicate using UP-based communications via UPF with applicable enhanced NFs (e.g., 6G NFs: data collection, sensing, positioning).

Referring to FIG. 6, an example of an evolved system architecture for WTRU-NF communication is shown. One difference with hybrid architecture shown at FIG. 5, may be that the WTRU may use RAN as an SBI gateway for CP-terminated communications. The enhanced functionalities (e.g., security proxy function (SPF), KMF) introduced in the architectures described at FIG. 5 and FIG. 6 may be defined as follow.

About the SBI proxy function or security proxy function (e.g., SPF, 6G SPF or SRPF):
(i) The SPF may act as a reverse proxy towards 6G NFs on the SBI. The SPF may forward requests/responses between a WTRU and NFs. The SPF may provide a security termination point for WTRU communication with NFs. The SPF may provide network topology hiding (from WTRUs, from outside the network). The SPF may provide support for 6G NF discovery and selection to allow WTRU to connect with the NF.
(ii) The SPF may be in a path between a UPF and a NF for UP-based communications. Similarly, a RAN may use a SPF (e.g., via SBI) as a security termination point for CP-based communication. As such, an SPF may abstract 6GC NFs discovery/selection from RAN. The SPF may be co-located with UPF, RAN, or other proxy NF such as service communication proxy (SCP). The SPF may be co-located or play the role of a security gateway to provide unified access to network services (over SBI) to WTRU connecting via 3GPP or non-3GPP (e.g., WiFi) access.
(iii) The SPF addressing information (e.g., fully qualified domain name (FQDN)) may be pre-configured in the WTRU or preconfigured in the RAN. The SPF addressing information may be provided to the WTRU, by the network, for example in a NAS procedure (e.g., registration, PDU session establishment, WTRU configuration update). Alternatively, the SPF address/NF Id may be provided by the RAN, (e.g., based on the NF the WTRU wants to contact). The WTRU may discover a SPF addressing info. For example, the WTRU may construct an SPF address information based on a serving public land mobile network (PLMN) name. As one or more SPFs may be assigned to serve a WTRU, the WTRU may be configured or receive the SPF addressing information of one or more SPFs.

About the key management function (e.g., KMF or 6G KMF):
(i) The KMF may provide a network key management service (e.g., SBI service) to NFs and to a WTRU (e.g., key generation, distribution, revocation). The KMF may provide key material used for establishing secure communications with the NF (e.g., between the WTRU and the NF). Using KMF service operations, each NF can establish a security association with the WTRU, independent of other NFs' security associations.
(ii) The KMF may be deployed in visited PLMN (VPLMN) and/or home PLMN (HPLMN) to provide differentiated security at the VPLMN and/or HPLMN. For example, with KMF deployed in HPLMN, the system may provide means for end-to-end secure communications between a WTRU and a NF in HPLMN (e.g., for policy provisioning, transmission of steering of roaming (SoR) information). KMF located in the HPLMN may provide for more operator control of WTRU-NF end-to-end (E2E) secure communications. The KMF may be co-located with other functions (e.g., AMF, SEAF, AUSF).
(iii) The KMF may provide key distribution over UP to the WTRU. The WTRU may request key material from KMF over a secure connection over UP (e.g., using GBA, AKMA).

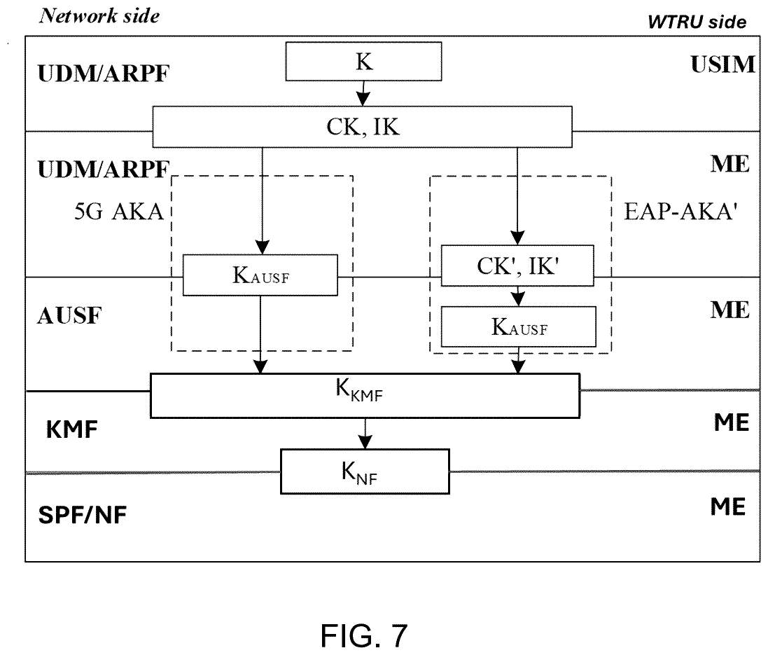

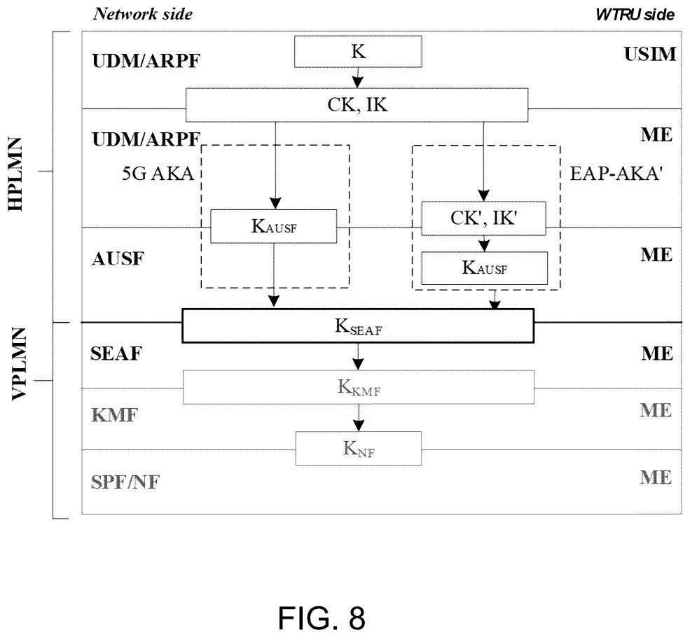

FIG. 7 and FIG. 8 illustrate and example of a key hierarchy for a support of secure end-to-end communications between a WTRU and NF in HPLMN and VPLMN respectively.

Referring to FIG. 7 and FIG. 8, following a successful primary authentication, the AUSF or SEAF may provide the KMF with a root key (K_{KMF}) and associated unique key identifier (K_{KMF} ID) used as a root of security for communications between the WTRU and NFs. The K_{KMF} may be derived from an anchor key (e.g., K_{SEAF} if derived at SEAF, KMF if derived at AMF) or a network intermediate key (K_{AUSF} if derived at AUSF). An example of a key derivation function for K_{KMF} may be: K_{KMF}=KDF (K_{AUSF} or K_{SEAF}, parameters) where parameters may include any of the following: (i) WTRU ID (e.g., SUPI) where WTRU ID may be a long-term identity of the WTRU; and <string> as a standardized string for a network key management service (NKMS) feature enabled with KMF (e.g., “NKMS”.).

To be able to locate the K_{KMF} in the KMF, the key identifier K_{KMF} ID may be derived in such a way as to ensure its uniqueness in the KMF. For example, K_{KMF} ID may be cryptographically bound to the WTRU identity (e.g., subscription permanent identifier (SUPI)). An example of a key derivation function for K_{KMF} ID may be: K_{KMF} ID=KDF (K_{AUSF} or K_{SEAF}, parameters) where parameters may include any of the following: (i) WTRU ID (e.g., SUPI) where WTRU ID may be a long-term identity of the WTRU; and (ii) <string> as a standardized string for the key identifier, e.g., “KMF-TID”.

To enable a secure connection establishment between the WTRU and an NF, a shared key K_{NF} (and identifier) may be derived at the KMF and WTRU using K_{KMF}. To provide each NF with a unique shared key K_{NF}, an NF-specific parameter may be used as part of the K_{NF} derivation. An example of a key derivation function for K_{NF} may be: K_{NF}=KDF (K_{KMF}, parameters), wherein the parameters may include any of the following: (i) a NF name which indicates a name of the NF or the network service (e.g., “PCF”, “NWDAF”, “Data Collection”, “Sensing”) the WTRU may determine to connect to; (ii) a NF ID (e.g., FQDN, IP address, NF instance id); (iii) one or more (e.g., freshness) parameters, which may comprise a pair of cryptographic nonces (e.g., monotonic counter or any value that is used once throughout K_{KMF} lifetime to ensure freshness of the K_{NF}) exchanged between WTRU and network during the WTRU-NF communication establishment; (iv) a counter maintained at the WTRU and the network (e.g., count of number of WTRU NF connections incremented at WTRU and KMF); and (v) WTRU long term identifier (SUPI).

A key lifetime may be associated with the K_{NF}. The KMF may determine key lifetime based on security policy and for example based on the NF type. The KMF may provide the WTRU and NF the key lifetime. The KMF may provide the WTRU with the key lifetime as part of the NF information (e.g., during registration, authentication, PDU session establishment/modification, WTRU configuration update). The KMF may provide the NF with key lifetime along with K_{NF} on condition that K_{NF} is requested by the NF. A K_{NF} may be valid as long as the key lifetime is not expired. If the key lifetime is expired while the WTRU is not connected with NF, a new K_{NF} may be derived by the WTRU and KMF during WTRU-NF connection establishment. The key may be refreshed as part of the active communication between the WTRU-NF. A new K_{NF} may re-keyed following a change of root key. When the NF obtain a new K_{NF} from KMF (e.g., due to key lifetime expiry or re-key for an active connection), the NF may initiate an update of the session keys or re-authentication of the WTRU according to the key agreement protocol in use (e.g., TLS, IKEv2) and/or based on policy. Alternatively, the WTRU and NF may restart the connection to establish a fresh key.

The K_{KMF} may be re-keyed when a new primary authentication is performed.

During the WTRU-NF communication establishment procedure, the WTRU may transmit the K_{KMF} ID to the NF. The WTRU may send along the K_{KMF} ID additional routing information to locate the KMF instance (e.g., routing ID (RID), SUPI realm, PLMN ID (MCC+MNC)). The NF may provide the K_{KMF} ID when requesting a K_{NF} from KMF. The K_{NF} may be derived and transmitted by KMF to the NF during a registration procedure, a PDU session establishment/modification, or a connection establishment between the WTRU and the NF.

The WTRU and NF may use K_{NF} as a pre-shared key (PSK) in mutual authentication and/or key agreement protocol. The authentication and key exchange methods used for e.g., generation of the session keys and security keys (not shown in the figure), may depend on a security protocol used between the WTRU and NF (e.g., IPSec Security Association (SA), establishment of child SAs with IKEv 2, session and traffic keys in TLS 1.3).

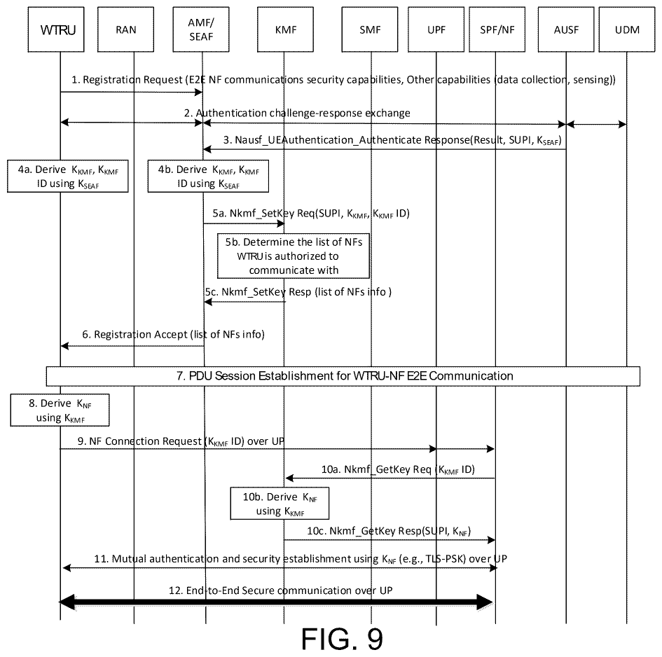

Referring to FIG. 9, an example of procedure to establish a secure end-to-end connection between the WTRU and an NF based on network access security is shown. The WTRU and the network (e.g., SEAF) may generate a root key K_{KMF} following a successful primary authentication. The WTRU and KMF in the VPLMN may generate a shared key (K_{NF}) for the connection with NF based on its existing network access security association (K_{KMF}). The KMF may provide the NF with the shared key (K_{NF}) as part of the connection establishment between the WTRU and the NF. The KMF may provide the WTRU with information about the NFs the WTRU may be authorized to connect with. The WTRU and the NF may perform a mutual authentication using K_{NF} as a pre-shared key in a key agreement protocol (e.g., IKEv2 or TLS) to establish the security for the connection.

Accordingly, in an embodiment, referring to FIG. 9, at step 1, the WTRU may transmit a registration request message to the network providing its end-to-end WTRU-NF communication security capabilities, which may include the security protocol/algorithms supported. The WTRU may provide other capabilities such as data collection and capabilities related to sensing.

Referring to FIG. 9, at step 2, the WTRU may perform a primary authentication with the network (e.g., AKA or EAP-AKA′). Note that alternatively to e.g., AKA, 3GPP AKA, 5G AKA, or EAP-AKA', any authentication and key agreement, e.g., based on public key infrastructure or “naked” public/private key pairs can be used for authentication and deriving a shared secret between the WTRU and HPLMN/VPLMN (e.g., K_{SEAF}.) Referring to FIG. 9, at step 3, upon successful completion of the authentication, the AUSF may transmit to SEAF, any of the result of the authentication, the SUPI, and a K_{SEAF}.

Referring to FIG. 9, at step 4a and step 4b, the WTRU and SEAF may respectively derive a new K_{KMF} and K_{KMF} ID using K_{SEAF}.

Referring to FIG. 9, at step 5a, the SEAF may transmit a request message to KMF including the SUPI, K_{KMF}, and K_{KMF} ID. The KMF may store the SUPI, K_{KMF}, and K_{KMF} ID in a key management context for the WTRU.

Referring to FIG. 9, at step 5b, the KMF may determine a list of NFs that the WTRU is authorized to perform end-to-end communication with. The KMF may also determine the information needed for the WTRU to establish communication with the NFs. For example, for each NF, the information may indicate the NF ID and/or addressing information (e.g., as FQDN, as a service name e.g. “NWDAF”), an associated key lifetime, the authentication and security protocol supported (e.g., TLS, IKEv2, extensible authentication protocol (EAP)). The KMF may determine the NF information based on subscription data from a unified data management (UDM) and/or policy information obtained from a policy control function (PCF) (not shown in the figure) and the WTRU capabilities.

Referring to FIG. 9, at step 5c, the KMF may transmit a response message to AMF/SEAF that may include the list of NFs information.

Referring to FIG. 9, at step 6, the AMF may transmit a registration accept message to the WTRU that may include the list of NFs information. Alternatively, during other procedures, as for instance during a WTRU configuration (e.g., in WTRU configuration update (UCU)), the WTRU may receive, from the network, the list of NFs information (e.g., from a PCF).

Referring to FIG. 9, at step 7, the WTRU may establish a PDU session to be used for communications with a target NF (if not already established). The WTRU may establish a new or may select an existing PDU session based on WTRU route selection policy (URSP) rules provisioned in the WTRU. The URSP rules provisioned in the WTRU may match NF information received in step 6 (e.g., service name or FQDN of the target NF).

Referring to FIG. 9, at step 8, the WTRU may derive a new K_{NF} using K_{KMF} derived in step 4 and other parameters, such as, for example, NF information (e.g., service name or FQDN) received in step 6, a (e.g., freshness) parameter etc.

Referring to FIG. 9, at step 9, the WTRU may transmit a connection request message to the NF over UP (e.g., using Hypertext Transfer Protocol (HTTP) transport), for example using the addressing information of the NF as received in step 6 and/or the PDU session established in step 7. The WTRU includes the K_{KMF} ID in the message (e.g., ClientHello message).

Referring to FIG. 9, at step 10a, the NF may transmit a request message to KMF to get a K_{NF}. The request message may include the K_{KMF} ID and NF information (e.g., service name or FQDN).

Referring to FIG. 9, at step 10b, the KMF may locate the K_{KMF} and SUPI using the received K_{KMF} ID. The KMF may derive a K_{NF} using the K_{KMF} and parameters (similarly to the WTRU in step 8).

Referring to FIG. 9, at step 10c, the KMF may transmit a response message to the NF that may include any of the SUPI, the K_{NF} and the key lifetime. The KMF may store the NF information in the WTRU key management context for key update or revocation purposes.

Referring to FIG. 9, at step 11, the WTRU and the NF may perform a mutual authentication procedure (e.g., TLS-PSK or IKEv2 with PSK) over the UP connection. In addition, the WTRU and the NF may establish keys (e.g., session and security keys) based on the key agreement protocol used.

Referring to FIG. 9, at step 12, the WTRU and the NF may communicate securely end-to-end over the UP connection.

In an embodiment, the WTRU may transmit a (e.g., explicit) request message to a RAN (e.g., as an alternative to a NAS registration message to the core network) for the purpose of accessing the network and/or bootstrapping a root key K_{KMF}. The RAN may trigger (e.g., via SBI) the authentication with an authentication function (e.g., SEAF, AUSF). The authentication function may initiate an authentication on condition that the WTRU is not already authenticated. The authentication function may inform the RAN of the authentication result. The RAN may retrieve the list of NFs information from the KMF upon receiving a successful authentication result on the condition that the WTRU is authorized for NF direct communications. The RAN may transmit a response message to the WTRU including the NFs information or a rejection message.

In an embodiment, the WTRU may indicate any of an NF information (e.g., NF name, service name), a routing ID, and a first (e.g., freshness) parameter in a PDU session establishment/modification request message (as shown in step 7), that the WTRU may determine to use to communicate with the NF. The SMF may send a request message to KMF to check whether the WTRU is authorized to communicated with NF. The SMF may include any of the SUPI, the NF information and the first (e.g., freshness) parameter in the message. The SMF may receive a positive response from KMF that includes a second (e.g., freshness) parameter on condition that the WTRU is authorized. The SMF may select an NF instance based on the NF name and/or routing ID (e.g., using an NRF). The SMF may allocate the resources based on quality of service (QOS) policy from a PCF for the WTRU-NF communication. The SMF may configure the connection based on the QoS policy from a PCF for the WTRU-NF communication. The SMF may provide the PCF the NF information to obtain a QoS policy adapted for that WTRU-NF communication. For example, delay sensitive, high bit rate QoS may be required and provisioned in UPF/RAN for WTRU communication with a sensing control NF, while less delay sensitive may be provisioned in the case of WTRU communicating with an AI/ML data collection NF. The SMF may provide any of NF specific information (e.g., NF ID) and the second (e.g., freshness) parameter in the PDU session establishment accept/PDU session command message. The WTRU and the KMF may use the first and the second (e.g., freshness) parameters to derive the K_{NF} in a subsequent WTRU-NF connection establishment steps as described above.

In an embodiment, a WTRU may bootstrap a shared security key (K_{NF}) from a network anchor key (e.g., K_{SEAF}) and may use the shared security key to establish an E2E secure connection over UP with NF in the network. Accordingly, a method implemented in a WTRU may comprise a step wherein the WTRU may receive, from the network, a UP connection termination point information for NF communications (e.g., NF FQDN, routing/instance id, service name, a freshness parameter, and an associated key lifetime for the service) during a NAS procedure (e.g., registration, PDU Session Establishment). The method may further comprise a step wherein the WTRU may derive an UP-communication root key and/or its identifier (e.g., K_{KMF}, K_{KMF} ID) using an anchor key or using an intermediate key (e.g., K_{SEAF}, K_{AUSF}) established during a primary authentication. The NF that performs WTRU authentication (e.g., SEAF, AMF, AUSF) may store the K_{KMF} key and the K_{KMF} identifier in KMF. The method may further comprise a step wherein the WTRU may establish a PDU session to communicate with an NF over UP. The method may further comprise a step wherein the WTRU may derive an NF Key (e.g., K_{NF}) using any of K_{KMF}, UP termination point information, and (e.g., freshness) parameter(s). The WTRU may transmit a connection request over UP using the UP termination point. The connection request may include the K_{KMF} ID. The NF/SPF may obtain a K_{NF} key from KMF using the K_{KMF} ID. The method may further comprise a step wherein the WTRU may perform a mutual authentication with the NF using the K_{NF} key valid for the key lifetime. The WTRU may secure the communication with the NF using the K_{NF} key valid for the key lifetime. The method may further comprise a step wherein the WTRU may exchange data (e.g., service operation, data transfer) with the NF over the secure E2E connection.

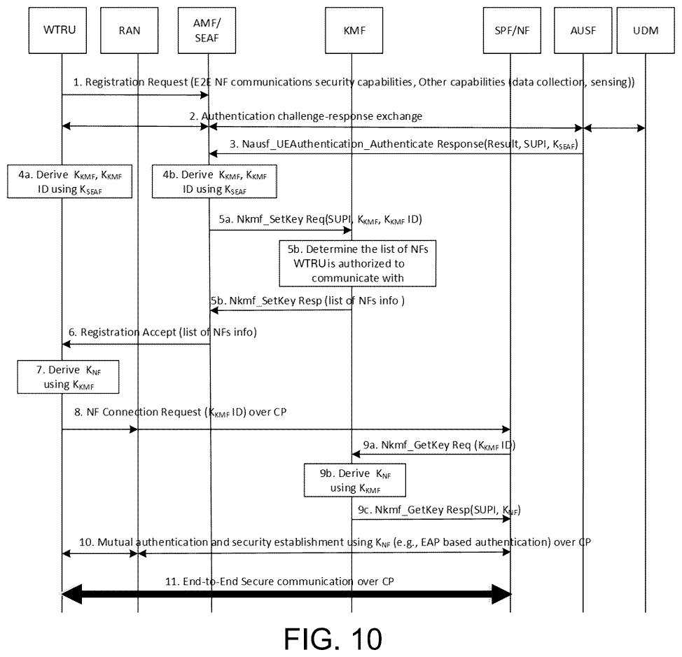

Referring to FIG. 10, an example of a procedure to establish a secure end-to-end connection between the WTRU and an NF based on network access security is shown. The main difference with the procedure illustrated at FIG. 9, is that the connection and the mutual authentication between the WTRU and the NF may be performed over CP (via RAN and/or AMF). The WTRU and the NF may perform a mutual authentication using K_{NF} in a protocol carried over CP (e.g., EAP-based).

Referring to FIG. 10, steps 1 to 6 are similar to steps 1 to 6 of FIG. 9 as described above.

Referring to FIG. 10, at step 7, the WTRU may derive a new K_{NF} using K_{KMF} derived in step 4 and/or NF information (e.g., service name or FQDN) received in step 6.

Referring to FIG. 10, at step 8, the WTRU may transmit a connection request message to the NF over CP (e.g., using RRC transport). The WTRU may include the K_{KMF} ID and/or NF information. With RAN support for SBI, RAN may discover the NF (e.g., using an NRF) based on received NF information. The RAN may forward the connection request message to the NF. The RAN may use routing information (e.g., RID) as part of the K_{KMF} ID for routing to the proper NF instance.

Referring to FIG. 10, step 9 is similar to step 10 of FIG. 9 as described above.

Referring to FIG. 10, at step 10, the WTRU and the NF may perform a mutual authentication procedure (e.g., using an EAP-PSK EAP method) over a CP connection. The WTRU and the NF may establish a session and security keys based on the key agreement protocol used. In the proposed EAP-based authentication, the RAN may play the role of the EAP authenticator while the NF may play the role of the EAP authentication server.

Referring to FIG. 10, at step 11, the WTRU and the NF may communicate securely end-to-end over the CP connection. The RAN may forward transparently messages protected end-to-end exchanged between the WTRU and the NF based on endpoints identification in messages (i.e., respectively NF ID in RRC message received from the WTRU and WTRU ID in SBI message received from NF).

In an embodiment, a WTRU may bootstrap a shared security key (K_{NF}) from a network anchor key (e.g., K_{SEAF}) and uses the shared security key to establish an E2E secure connection over CP with NF in the network. Accordingly, a method implemented in a WTRU may comprise a step wherein the WTRU may receive from the network a CP NAS termination point information for NF communications (e.g., routing/instance ID, service name, a (e.g., freshness) parameter, and an associated key lifetime for the service) during a NAS procedure (e.g., authentication, registration). The method may further comprise a step wherein the WTRU may derive a CP communication root key and its identifier (e.g., K_{KMF}, K_{KMF} ID) using an anchor key or intermediate key (e.g., K_{SEAF}, K_{AUSF}) established during a primary authentication. The method may further comprise a step wherein the WTRU may derive an NF Key (e.g., K_{NF}) using any of K_{KMF}, a CP NAS termination point information, and the (e.g., freshness) parameter. The method may further comprise a step wherein the WTRU may transmit a connection request message (for example: over RRC) using the CP termination point. The connection request message may include the K_{KMF} ID. The RAN may forward the connection request message over SBI to the NF associated with the CP termination point. The NF may obtain a K_{NF} key from KMF providing the K_{KMF} ID. The method may further comprise a step wherein the WTRU may perform a mutual authentication using the K_{NF} key valid for the key lifetime. The method may further comprise a step wherein the WTRU may secure the communication with the NF using the K_{NF} key valid for the key lifetime. The RAN may forward back and forth the authentication messages between the WTRU and NF. The method may further comprise a step wherein the WTRU may exchange data (e.g., service operation, data transfer) with the NF over the secure E2E connection.

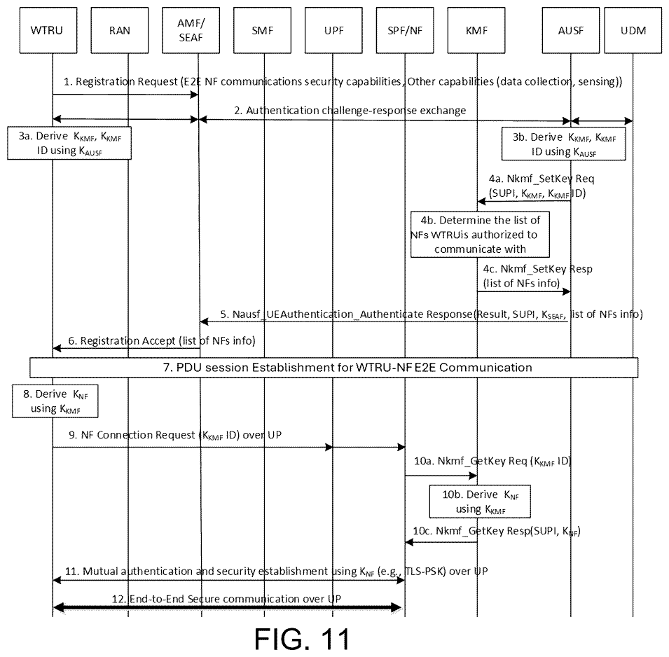

Referring to FIG. 11, an example of a procedure to establish a secure end-to-end connection between the WTRU and the NF in the HPLMN based on network access security is shown. The WTRU and the network (e.g., AUSF) may generate a root key K_{KMF} following a successful primary authentication. The WTRU and the KMF in the HPLMN may generate a shared key (K_{NF}) for the connection with NF based on its existing network access security association (K_{KMF}). The KMF may provide the NF with the shared key K_{NF} as part of the connection establishment between the WTRU and the NF. The KMF may provide the WTRU with information about the NFs the WTRU is authorized to connect with. The KMF may provide the WTRU with information about the NFs the WTRU can connect to. The WTRU and the NF may perform a mutual authentication using, for example, K_{NF} as a pre-shared key in a key agreement protocol (e.g., IKEv2 or TLS) to establish the transport security for the connection.

Referring to FIG. 11, steps 1 and 2 are similar to steps 1 and 2 of FIG. 9 as described above.

Referring to FIG. 11, at step 3a and step 3b, respectively, the WTRU and the AUSF may derive/determine a new K_{KMF} and K_{KMF} ID using K_{AUSF}.

Referring to FIG. 11, at step 4a, the AUSF may transmit a request message to KMF that may include any of the SUPI, the K_{KMF}, and the K_{KMF} ID.

Referring to FIG. 11, at step 4b, the KMF may store the SUPI, the K_{KMF}, and the K_{KMF} ID in a key management context for the WTRU. The KMF may determine a list of NFs that the WTRU is authorized to perform end-to-end communication with as described above. The list of NFs may include NFs in the HPLMN. This may allow an operator to control whether a WTRU may communicate with NFs in the operator's domain.

Referring to FIG. 11, at step 4c, the KMF may transmit a response message to the AMF/SEAF including, for example, the list of NFs information.

Referring to FIG. 11, at step 5, upon successful completion of the authentication, the AUSF may transmit to SEAF any of a result of the authentication, the SUPI, the K_{SEAF}, and the list of NFs information.

Referring to FIG. 11, at step 6, the AMF may transmit a registration accept message to the WTRU that may include the list of NFs information.

Referring to FIG. 11, steps 7 to 12 are similar to steps 7 to 12 of FIG. 9 as described above. In this procedure, the NF may be in HPLMN or VPLMN.

In an embodiment, a WTRU may bootstraps a shared security key (K_{NF}) from a network intermediate key (e.g., K_{AUSF}). The WTRU may use the shared security key to establish an E2E secure connection over CP with NF in the home network (HPLMN). Accordingly, in an embodiment, a method implemented in a WTRU may comprise a step wherein the WTRU may receive configuration about NFs information (e.g., FQDN, service, or NF name, a (e.g., freshness) parameter, and an associated key lifetime for the service) in the HPLMN (e.g., H-SPF, H-PCF). The method may further comprise a step wherein the WTRU may derive a root key K_{KMF} and a K_{KMF} ID for the HPLMN NF communication key based on K_{AUSF} (instead of K_{SEAF}). The AUSF mat derive the same and may store K_{KMF} and K_{KMF} ID in KMF in HPLMN (H-KMF). The method may further comprise a step wherein the WTRU may establish an E2E secure communication with the NF in HPLMN (via CP or UP) based on a shared key K_{NF} derived from the K_{KMF}. The secure communication may be for the duration of key lifetime derived from the K_{KMF}. The method may further comprise a step wherein the WTRU may transmit the root key identifier K_{KMF} ID in a network access identifier (NAI) format pointing to H-KMF in HPLMN to the network to connect with an NF. The method may further comprise a step wherein the WTRU may exchange information with NF in HPLMN over E2E secure connection (e.g., H-PCF policy, SoR, UPU).

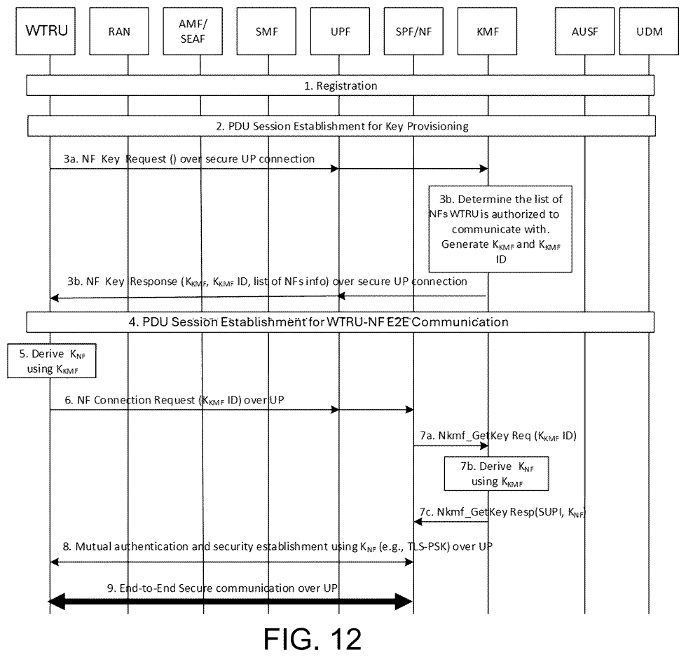

Referring to FIG. 12, an example of a procedure to establish a secure end-to-end connection between the WTRU and an NF based on a root key K_{KMF} provided by a KMF in the HPLMN is shown. The WTRU may receive from the KMF (e.g., over a secure UP connection), any of the K_{KMF}, a K_{KMF} ID and information about the NFs the WTRU is authorized to connect with. The UP connection security between the WTRU and the KMF may be established using a (e.g., 3GPP) bootstrapping protocol (e.g., GBA, AKMA). The KMF (in the HPLMN) may generate a shared key (K_{NF}) for the connection with NF based on its existing network access security association (K_{KMF}). The KMF may provide the NF with the shared key K_{NF} as part of the connection establishment between the WTRU and the NF. The WTRU and the NF may perform a mutual authentication using K_{NF} as a pre-shared key, for example, in a key agreement protocol (e.g., IKEV2 or TLS), to establish the security for the connection.

Referring to FIG. 12, at step 1, the WTRU may perform a registration procedure. The WTRU may be configured with KMF information (e.g., FQDN) during or after the procedure.

Referring to FIG. 12, at step 2, the WTRU may establish a PDU session to be used for the provisioning of key material used for WTRU-NF end-to-end communication.

Referring to FIG. 12, at step 3a, the WTRU may transmit a request message to the KMF, for example, over a secure UP connection, to obtain a K_{KMF}. The security of the connection between the WTRU and the KMF may be established using (e.g., standardized 3GPP) bootstrapping methods such as GBA or AKMA, where the KMF may play the role of an application function (AF).

Referring to FIG. 12, at step 3b, the KMF may obtain the SUPI from the UDM (e.g., via an AKMA Anchor Function (AAnF)). The KMF may determine a list of NFs that the WTRU is authorized to perform end-to-end communication with as described above. The list of NFs may include NFs in the VPLMN and/or the HPLMN. The KMF may generate/may determine any of a K_{KMF} and K_{KMF} ID. The KMF may store any of the SUPI, the K_{KMF}, and the K_{KMF} ID in a key management context for the WTRU.

Referring to FIG. 12, at step 3c, the KMF may transmit a response message including any of the K_{KMF}, the K_{KMF} ID, and the list of NFs information.

Referring to FIG. 12, steps 4 to 9 are similar to steps 7 to 12 of FIG. 11 as described above.

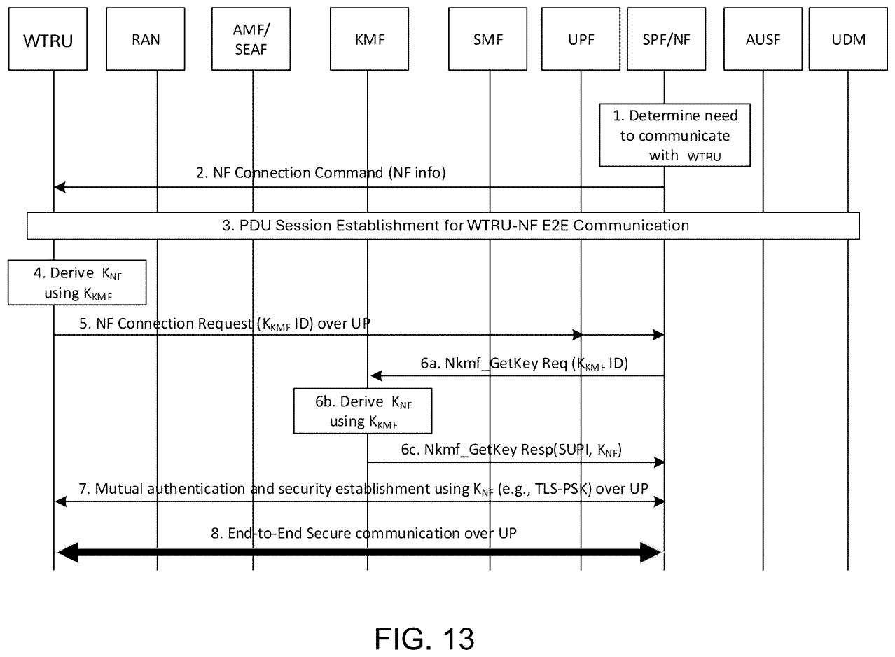

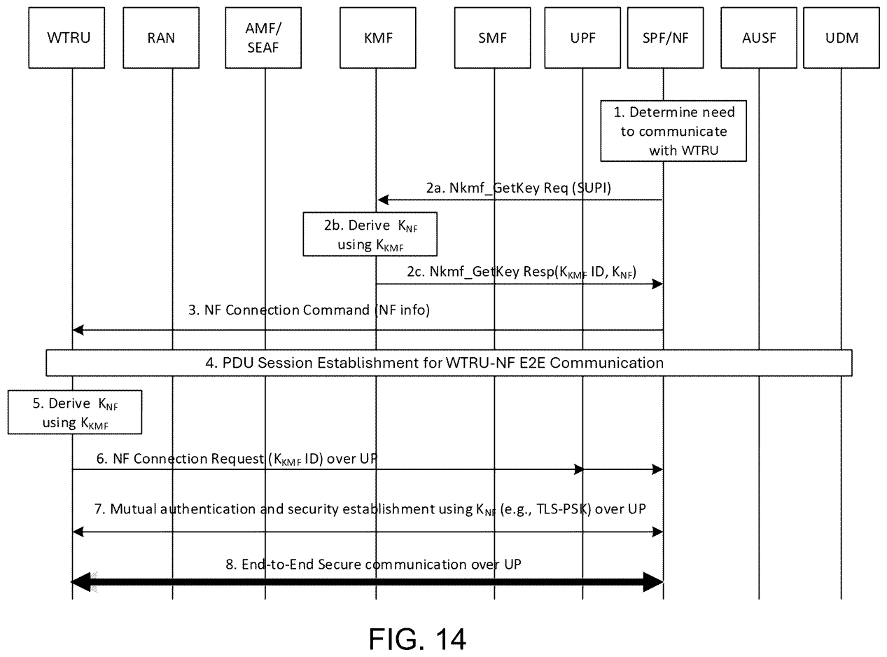

Referring to FIG. 13, an example of a procedure to establish a secure end-to-end connection between the WTRU and an NF over UP initiated by the network and based on network access security is shown. The NF may trigger the WTRU to connect over UP providing the WTRU with NF information. The WTRU may connect with NF over UP, performing mutual authentication using K_{NF} as a pre-shared key, for example, in a key agreement protocol (e.g., IKEv2 or TLS), to establish the security of the connection. In a first embodiment, the NF may obtain a K_{NF} when the WTRU requests a connection. In a second embodiment, referring to FIG. 14, the NF may obtain the K_{NF} prior to WTRU requesting a connection.

As a pre-condition of the below methods, the WTRU and the network have generated a root key K_{KMF} following a successful primary authentication (as described above).

Referring to FIG. 13, at step 1, the NF may connect with the WTRU over UP, based on WTRU capabilities (WTRU-NF communication capabilities). NF may connect with the WTRU over UP based on a trigger to perform an operation over UP (e.g., collecting training or sensing data)

Referring to FIG. 13, at step 2, the NF may transmit a connection command message to the WTRU that may include the NF information (e.g., FQDN). The NF may transmit the connection command message to the WTRU, for example, over CP (e.g., using NAS transport via AMF, RRC transport via RAN).

Referring to FIG. 13, steps 3 to 8 are similar to steps 7 to 12 of FIG. 9 as described above. The WTRU may derive the K_{NF} using NF information received in step 2 of FIG. 13.

Referring to FIG. 14, at step 1, the NF may connect with the WTRU, for example, over UP.

Referring to FIG. 14, at step 2a, the NF may transmit a request message to KMF to get a K_{NF}. The request message may include any of a WTRU ID (e.g., SUPI) and NF information (e.g., service name or FQDN).

Referring to FIG. 14, at step 2b, the KMF may locate the K_{KMF} using the received WTRU ID. The KMF may derive a K_{NF} using the K_{KMF} and NF information.

Referring to FIG. 14, at step 2c, the KMF may transmit a response message to the NF that may include the K_{KMF} ID and the K_{NF}.

Referring to FIG. 14, steps 3 to 8 are similar to steps 2 to 8 of FIG. 13 described above. The differences are that the NF may retrieve locally the K_{NF} using the received K_{KMF} ID. Furthermore, the NF may include a (e.g., freshness) parameter received from the KMF (e.g., as part of, or along NF information). The WTRU may derive a K_{NF} the same way as KMF using the K_{KMF} and parameters including the freshness parameters.

In an embodiment, the SPF may be deployed for its network topology hiding, and network abstraction properties.

As a security termination point in the network on behalf of NFs, the SPF may consolidate the key distribution load of KMF to fewer NFs. Furthermore, the SPF may offload security processing from the NFs. For example, the SPF may use dedicated hardware acceleration for encryption/decryption processing (e.g., IPSec, TLS, or SSL acceleration). The network operator may deploy as many SPF instances as needed to e.g., load-balance the security processing in the network and impact neither any particular NF nor the network performance as a whole. A WTRU may be served by one or more SPF instances, wherein each SPF instance may provide a security termination point to one or more NFs the WTRU communicates with.

Considering FIG. 9, steps 1-6: with SPF exposed to the WTRU (e.g., used as in non-transparent reverse proxy setup), the SPF information (e.g., FQDN) may be provided to the WTRU as part of the list of NFs information. The WTRU may be provided with one or more SPF information (e.g., SPF1 for CP, SPF2 for UP WTRU-NF communications). In general, an SPF instance may be associated with one or more NFs or network services. The KMF may determine the list of NF/SPF information to be sent to the WTRU accordingly.

Considering FIG. 9, steps 8-12: the WTRU may derive a K_{SPF} using SPF information (instead of NF information). The WTRU may include the NF ID or name when connecting to the SPF. The SPF may request a K_{SPF} from KMF providing its SPF information. The SPF may receive from the KMF the list of NFs the WTRU is authorized to communicate with. If the SPF has already obtained a K_{SPF} from a prior WTRU-NF session, the SPF may skip requesting the KMF. The SPF may perform mutual authentication of the WTRU using K_{SPF}.

If the WTRU is already connected via SPF, the WTRU may exchange messages with different NFs reusing the secure connection with the SPF. The SPF may verify that the NF addressing the WTRU or addressed by the WTRU in the message is part of the list of NFs the WTRU is authorized to communicate with before forwarding the message between the WTRU and the NF. In other words, once the WTRU has established a shared secure connection via SPF, the WTRU can communicate directly with an NF via the secure connection (e.g., without having to establish a new PDU Session or run through a new authentication procedure with the SPF).

In the network-initiated WTRU-NF connection establishment, the NF may discover and may select the SPF to serve or serving the WTRU. The NF may use the KMF to determine the serving SPF instance. For example, when the NF requests a K_{NF}, the KMF may send a response including the SPF information. The NF may transmit messages to the WTRU over the secure connection established with SPF. If no SPF is found at KMF, the NF may use the NRF to discover an SPF instance to initiate the WTRU-SPF secure connection establishment (where SPF plays the role of NF in the procedure described above).

In an embodiment, during the WTRU registration in the procedures above, the KMF may subscribe to UDM for subscription updates related to WTRU-NF communications. The KMF may establish a policy association with a PCF for WTRU-NF security policy handling.

The KMF may be notified by UDM or PCF about an update related to WTRU-NF communication authorization or policy (e.g., revocation of WTRU authorization to communicate with one or more NFs).

The KMF may use the NF information stored in the WTRU key management context to notify NFs/SMFs in the event of a K_{NF} revocation. The NF/SMF receiving the notification may release the connection with the WTRU.

In a setup with SPFs, a single SPF may handle the communication security with WTRU on behalf of one or more NFs (e.g., to ensure the scalability of the system). The KMF may notify the SPF indicating the one or more NFs for which the WTRU authorization to communicate has been revoked. Upon receiving the notification, the SPF may discard messages exchanged between the WTRU and the NFs indicated by the KMF. If the KMF notification to the SPF indicates that no NF is authorized for the WTRU or that the K_{SPF} is revoked, then the SPF may release its connection with the WTRU.

When the WTRU performs a re-authentication with the network (e.g., new K_{SEAF}, K_{AUSF}), a new K_{KMF}, K_{KMF} ID is derived by WTRU and network. Upon receiving a new K_{KMF}, the KMF may notify the NF/SPF providing a re-keyed K_{NF}/K_{SPF}. Upon receiving the new K_{NF}/K_{SPF}, the NF/SPF may trigger a re-keying or re-authentication procedure with the WTRU (e.g., using IKEv2, TLS, or EAP-specific re-keying or re-authentication methods).

In an embodiment, the K_{KMF} ID may be generated (using K_{SEAF} or K_{AUSF}) such as to prevent linkage (e.g., linkability attack) with a long-term identifier (SUPI). To mitigate risks of WTRU being tracked based on the K_{KMF} ID the following principles are applied.

The radio resource control (RRC) (CP) may be assumed to be confidentiality (and integrity) protected such that when the WTRU transmits a connection request to NF over CP the privacy of K_{KMF} ID is preserved.

Similarly, an UP security between a WTRU and a RAN may be confidentiality (and integrity) protected by default for PDU sessions used for WTRU-NF communications. With increasing data traffic towards NFs (e.g., for data collection), UP security optimization mechanism enablement may be considered. For example, the SMF may be informed by the serving SPF/NF that end-to-end security has been established between the WTRU and the NF. The SMF, in compliance with UP security policy, may indicate to the RAN to deactivate protection for UP (e.g., for all DRBs).

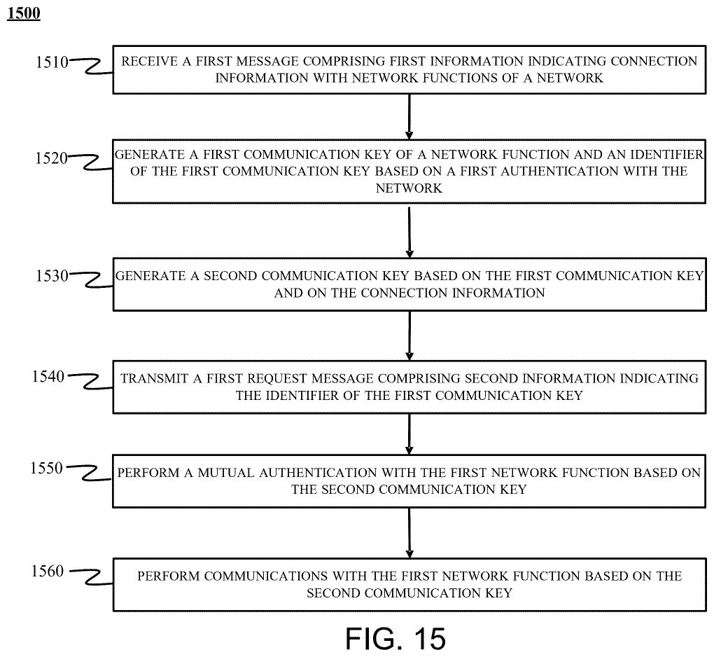

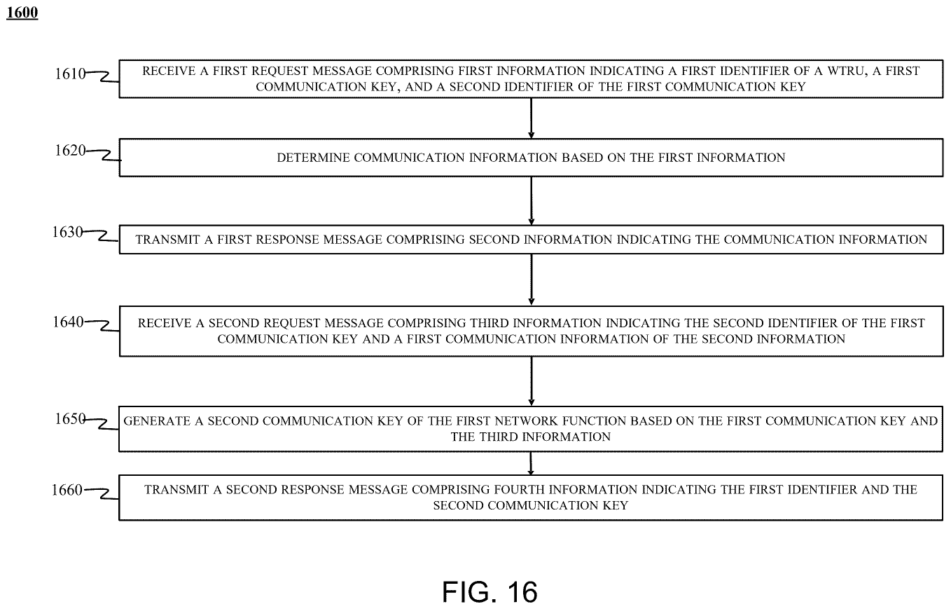

Referring to FIG. 15, an example of a method 1500 implemented in a WTRU, for a WTRU end-to-end secure connection establishment with a NF is shown. The method 1500 implemented in the WTRU refers to FIG. 9 as well as to FIG. 10 as being applicable for end-to-end connection establishment with a NF over a user plane (FIG. 9) or over a control plane (FIG. 10).

Referring to FIG. 15, in an embodiment, the method 1500, implemented in the WTRU, may comprise a step wherein the WTRU may receive 1510 a first message comprising first information indicating connection information with network functions of a network. The connection information may comprise information on connection to network functions through a user plane of the network or a control plane of the network. The first message may be received during a non-access stratum procedure.

The method 1500 may comprise a step wherein the WTRU may generate 1520 a first communication key for communication security establishment with the network functions of the network and an identifier of the first communication key based on a first authentication with the network. The first communication key may be a root key determined based on the first authentication with the network. The first communication key may be for communication through the user plane or through the control plane. Generating the first communication key may be based on a third communication key of the network established during a second authentication with the network. The third communication key may be an anchor key or an intermediate key determined based on the second authentication with the network. The first authentication with the network may be a primary authentication.

The method 1500 may comprise a step wherein the WTRU may generate 1530 a second communication key of a first network function of the network based on the first communication key and based on the connection information. The connection information with the network functions may indicate an identifier of the first network function. The second communication key may be a unique shared key for secure communication with the first network function of the network functions. The first information may further indicate a lifetime for the second communication key of the first network function.

The method 1500 may comprise a step wherein the WTRU may transmit 1540 a first request message to the first network function comprising second information indicating the identifier of the first communication key. The transmission of the first request message to the first network function may be over the user plane of the network or over the control plane of the network. The first request message may be a connection request message.

The method 1500 may comprise a step wherein the WTRU may perform 1550 a mutual authentication with the first network function based on the second communication key of the first network function. The mutual authentication may be performed using an authentication protocol. The connection information with the network functions may indicate the authentication protocol.

The method 1500 may comprise a step wherein the WTRU may perform 1560 one or more communications with the first network function based on the second communication key of the first network function. Performing the one or more communications with the first network function may be on condition that the lifetime for the second communication key is valid (e.g., is not expired).

The method 1500 may comprise a step wherein the WTRU may establish a PDU session, wherein the establishment of the PDU session is to enable communication with the first network function.

The connection information with the network functions may indicate a freshness parameter. A freshness parameter may comprise a pair of cryptographic nonces (e.g., monotonic counter or any value this is used once throughout a lifetime of the first communication key to ensure freshness of the second communication key) exchanged between the WTRU and the network during the WTRU-NF communication establishment.

The method 1500 may comprise a step wherein the WTRU may perform the one or more communications with the first network function under a security protocol. The first message may be a registration accept message, and wherein the method may comprise a step wherein the WTRU, prior to receive the first message, may transmit, to the network, a registration request message comprising WTRU to network function communication security capabilities information indicating the security protocol.

Referring to FIG. 16, an example of a flow chart diagram illustrating an example of a method 1600, implemented in a network node of a network, for a WTRU end-to-end secure connection establishment with a NF is shown. The method 1600 implemented in the network node refers to FIG. 9 as well as to FIG. 10 as being applicable for end-to-end connection establishment with a NF over a user plane (FIG. 9) or over a control plane (FIG. 10). As a non-limited example, the network node may comprise a key management function for a network key management service for any of network functions and a WTRU.

Referring to FIG. 16, in an embodiment, the method 1600, implemented in the network node of a network, may comprise a step wherein the network node may receive 1610 a first request message comprising first information indicating a first identifier of a WTRU, a first communication key for communication security establishment with network functions of the network, and a second identifier of the first communication key. The first communication key may be for communication security establishment with network functions of the network over a user plane of the network or over a control plane of the network. The first communication key may a root key determined based on a primary authentication between the network and the WTRU. The indication of the first information may be stored, by the network node, in a WTRU key management context.

The method 1600 may further comprise a step wherein the network node may determine 1620 one or more communication information based on the first information, wherein the one or more communication information is (are) are associated with one or more network functions for communication establishment with the WTRU, e.g., respectively. The one or more communication information may indicate any of one or more identifiers of respectively the one or more network functions, an authentication protocol and a security protocol. The determination of the one or more communication information may be further based on any of subscription data of the WTRU from a unified data management function, policy information, and capabilities of the WTRU. The one or more communication information may indicate one or more communication key lifetime associated with respectively one or more communications between the WTRU and the one or more network functions.

The method 1600 may further comprise a step wherein the network node may transmit 1630 a first response message comprising second information indicating the one or more communication information.

The method 1600 may further comprise a step wherein the network node may receive 1640 a second request message comprising third information indicating the second identifier of the first communication key and a first communication information of the second information, wherein the first communication information is associated with a first network function of the one or more network functions.

The method 1600 may further comprise a step wherein the network node may generate 1650 a second communication key of the first network function based on the first communication key and the third information. The second communication key may be a unique shared key for secure communication between the first network function and the WTRU. The secure communication with the first network function may be over the user plane or over the control plane.

The method 1600 may further comprise a step wherein the network node may transmit 1660 a second response message comprising fourth information indicating the first identifier of the WTRU, and the second communication key. The fourth information may further indicate a key lifetime associated with the second communication key. The indication of the fourth information may be stored, by the network node, in the WTRU key management context.

The method 1600 may further comprise a step wherein the network node may determine one or more network functions authorized for end-to-end communication with the WTRU based on the first information, wherein the one or more communication information is (are) associated with the authorized one or more network functions, e.g., respectively.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method, implemented in a wireless transmit/receive unit (WTRU), the method comprising:
receiving a first message comprising first information indicating connection information with network functions of a network;
generating a first communication key for communication security establishment with the network functions of the network and an identifier of the first communication key based on a first authentication with the network;
generating a second communication key of a first network function of the network based on the first communication key and based on the connection information;
transmitting a first request message to the first network function comprising second information indicating the identifier of the first communication key;
performing a mutual authentication with the first network function based on the second communication key of the first network function; and
performing one or more communications with the first network function based on the second communication key of the first network function.

2. The method of claim 1, wherein the first communication key is a root key determined based on the first authentication with the network, wherein the first authentication with the network is a primary authentication.

3. The method of claim 1, wherein the second communication key is a unique shared key for secure communication with the first network function.

4. The method of claim 1, comprising generating the first communication key based on a third communication key of the network established during a second authentication with the network.

5. The method of claim 4, wherein the third communication key is an anchor key or an intermediate key determined based on the second authentication with the network.

6. The method of claim 1, wherein the first information further indicates a lifetime for the second communication key of the first network function, and wherein performing the one or more communications with the first network function is on condition that the lifetime for the second communication key is valid.

7-8. (canceled)

9. The method of claim 1, wherein the connection information with the network functions indicates an identifier of the first network function.

10. The method of claim 1, to claim wherein the connection information with the network functions indicates a freshness parameter.

11. The method of claim 1, comprising transmitting the first request message to the first network function over a user plane of the network.

12-14. (canceled)

15. The method of claim 1, comprising establishing a protocol data unit (PDU) session, wherein the establishment of the PDU session is to enable communication with the first network function.

16. (canceled)

17. A wireless transmit/receive unit (WTRU) comprising a processor, a transmitter, a receiver, and a memory, and configured to:
receive a first message comprising first information indicating connection information with network functions of a network;
generate a first communication key for communication security establishment with the network functions of the network and an identifier of the first communication key based on a first authentication with the network;
generate a second communication key of a first network function of the network based on the first communication key and based on the connection information;
transmit a first request message to the first network function comprising second information indicating the identifier of the first communication key;
perform a mutual authentication with the first network function based on the second communication key of the first network function; and
perform one or more communications with the first network function based on the second communication key of the first network function.

18. The WTRU of claim 17, wherein the first communication key is a root key determined based on the first authentication with the network, wherein the first authentication with the network is a primary authentication.

19. The WTRU of any of claim 17, wherein the second communication key is a unique shared key for secure communication with the first network function.

20. The WTRU of claim 17, configured to generate the first communication key based on a third communication key of the network established during a second authentication with the network.

21. The WTRU of claim 20, wherein the third communication key is an anchor key or an intermediate key determined based on the second authentication with the network.

22. The WTRU of claim 17, wherein the first information further indicates a lifetime for the second communication key of the first network function, and wherein performing the one or more communications with the first network function is on condition that the lifetime for the second communication key is valid.

23-24. (canceled)

25. The WTRU of claim 17, wherein the connection information with the network functions indicates an identifier of the first network function.

26. The WTRU of claim 17, wherein the connection information with the network functions indicates a freshness parameter.

27. The WTRU of claim 17, configured to transmit the first request message to the first network function over a user plane of the network.

28-30. (canceled)

31. The WTRU of claim 17, configured to establish a PDU session, wherein the establishment of the PDU session is to enable communication with the first network function.

32-42. (canceled)
